(19) United States
(12) Patent Application Publication
(10) Pub. No.: US 2012/0311022 A1
(43) Pub. Date: Dec. 6, 2012

(54) LOAD DISTRIBUTION SERVER SYSTEM FOR PROVIDING SERVICES ON DEMAND FROM CLIENT APPARATUS CONNECTED TO SERVERS VIA NETWORK

(76) Inventor: Akira WATANABE, Osaka (JP)

(21) Appl. No.: 13/486,329

(22) Filed: Jun. 1, 2012

(30) Foreign Application Priority Data
Jun. 3, 2011 (JP) 2011-124814
May 25, 2012 (JP) 2012-120021

(51) Int. Cl. G06F 15/16

(52) U.S. Cl. 709/203

(57) ABSTRACT

A load distribution server system is provided for providing a plurality of services on demand from a client apparatus, to which a plurality of servers are connected via a network for the client apparatus. Servers operate as virtual servers for the client apparatus, and take charge of services to share respective service functions and mutually transceive keep alive messages. When the keep alive message of at least one server is not received or when reception of the keep alive message is restarted in at least one server, the service function of the server of which the keep alive message is not received is allocated to at least one other server on the basis of a predetermined priority of the service function, and a virtual server corresponding to the allocated service function is activated to provide the service of the service function.

### BACKGROUND OF THE INVENTION

1. Field of the Invention

The present invention relates to a server system having a redundancy and a load distribution function for use in a mobile service system for providing television broadcasting, radio broadcasting and announcement services for individual passengers in a mobile object such as an aircraft.

2. Description of the Related Art

In recent years, television broadcasting, radio broadcasting and announcement services by the crew have been provided by using client apparatuses such as monitors and loudspeakers installed at passenger's seats and a server for controlling these apparatuses in a mobile object such as an aircraft.

On the other hand, there have been the practices of constituting the server system of a plurality of servers for improvements in the reliability and the performance of the server system and making the server redundant and load-distributed. Making the server redundant as mentioned above has been known, where a redundant architecture can be actualized by a system in which the clients and the servers are connected via a network. In the server system used in this case, servers classified into an operation system and a standby system are installed to monitor each other. When the server of the operation system enters an abnormal state, the server of the standby system takes over the control to execute control of the connected client apparatuses, and this leads to allowing the function of the whole system to be maintained, and therefore, the reliability of the server system is secured.

On the other hand, the load distribution of the server has been known, where the clients and the plurality of servers are connected together via a network, and the servers share the roles. When a malfunction or a trouble occurs in any of the servers, the plurality of other servers act to share the functions of the server.

According to the technology of another prior art technology, when making the server system redundant, one server is operated as an exercising system or an executing system, and switchover to the standby system server takes effect when the normality of the operation system server cannot be confirmed. That is, only the operation system server is normally operated, and the standby system server is not operating, and then, this leads to such a problem that the resources of the other servers cannot be effectively utilized.

Moreover, according to this technology, when achieving the load distribution of the server system, it is only possible to evenly distribute the function of the server in which the malfunction has occurred to the plurality of other servers. Accordingly, there is such a problem that the loads of the plurality of other servers become heavy since the servers take charge of another function in addition to their own functions, and processing consequently becomes slow.

However, in the server system in an aircraft or the like, it is necessary to fulfill a plurality of service functions of different levels of importance. In concrete, the announcement service in the aircraft is ranked as the most important service to continue flight, and the slow processing of the server that performs the service leads to impairing the safety of the flight of the aircraft.

### SUMMARY OF THE INVENTION

An object of the present invention is to provide a load distribution server system capable of effectively utilizing the server resources and improving the system reliability by simultaneously making the server system redundant and load-distributed.

In order to achieve the aforementioned objective, according to one aspect of the present invention, there is provided a load distribution server system for providing a plurality of services on demand from a client apparatus, to which a plurality of servers are connected via a network for the client apparatus. The plurality of servers operate as virtual servers for the client apparatus, and the plurality of servers take charge of the plurality of services to share respective service functions and mutually transceive keep alive messages. When the keep alive message of at least one server is not received or when reception of the keep alive message is restarted in at least one server, the service function of the server of which the keep alive message is not received is allocated to at least one other server on the basis of a predetermined priority of the service function, and a virtual server corresponding to the allocated service function is activated to provide the service of the service function.

In the above-mentioned load distribution server system, when the keep alive message of at least one server is not received or when reception of the keep alive message is restarted in at least one server, at least one other server retrieves a service function having a maximum priority among the service functions that have not been allocated in the load distribution server system, and in a case where there is a resource required for the service function, the retrieved service function is allocated to the resource, and a virtual server corresponding to the allocated service function is activated to provide the service of the service function.

Alternatively, in the above-mentioned load distribution server system, when the keep alive message of at least one server is not received or when reception of the keep alive message is restarted in at least one server, at least one other server retrieves a service function having a maximum priority among the service functions that have not been allocated in the load distribution server system, and in a case where there is a service function having a minimum priority when there is no resource required for the service function, the service function is stopped and the remaining resources are updated, and thereafter, the service function having the maximum priority is retrieved from among the service functions that have not been allocated in the load distribution server system.

In addition, in the above-mentioned load distribution server system, when the keep alive message of at least one server is not received or when reception of the keep alive message is restarted in at least one server, at least one other server retrieves the service function having the maximum priority from among the service functions that have not been allocated in the load distribution server system, and in a case where there is no service function having the minimum priority when there is no resource required for the service function, allocation of the service function having the maximum priority is stopped.

Further, in the above-mentioned load distribution server system, the load distribution server system is a service system provided in an aircraft.

Therefore, according to the load distribution server system of the present invention, the effective utilization of the server resources and the improvement in the system reliability can be improved by allowing the server system to be load-distributed and redundant concerning the service functions according to a priority.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a block diagram showing a configuration of a load distribution server system according to a first preferred embodiment of the present invention;

FIG. 2 is a tabulation showing service function management tables 102 at and 102bt stored in the storage apparatuses of servers 102a and 102b, respectively, of the load distribution server system of FIG. 1;

FIG. 3 is a flow chart showing a service function allocating process for virtual servers executed by the server 102a of the load distribution server system of the first preferred embodiment of the present invention; and

FIG. 4 is a flow chart showing a service function allocating process for virtual servers executed by the server 102a of a load distribution server system according to a second preferred embodiment of the present invention.

### DETAILED DESCRIPTION OF THE PREFERRED EMBODIMENTS

Preferred embodiments of the present invention will be described below with reference to the drawings.

### First Preferred Embodiment

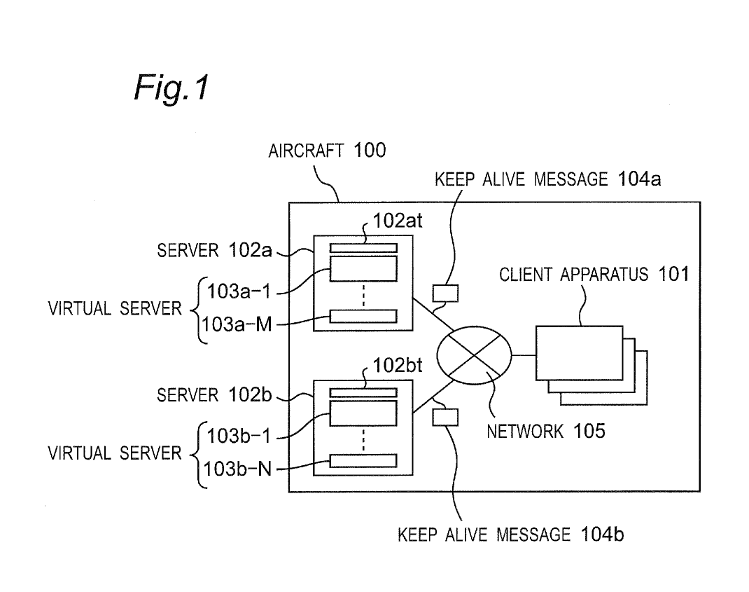

FIG. 1 is a block diagram showing a configuration of a load distribution server system according to a first preferred embodiment of the present invention.

As shown in FIG. 1, a plurality of client apparatuses 101 such as monitors and loudspeakers installed at passenger's seats exist in an aircraft 100, and the apparatuses are connected to a plurality of servers (physical servers) 102a and 102b via a local area network (hereinafter, referred to as a network) 105 of, for example, wireless LAN or wired Ethernet (registered trademark). Although the servers 102a and 102b are described as two in number in the present preferred embodiment, the number is not limited because the servers 102a and 102b are provided according to service functions.

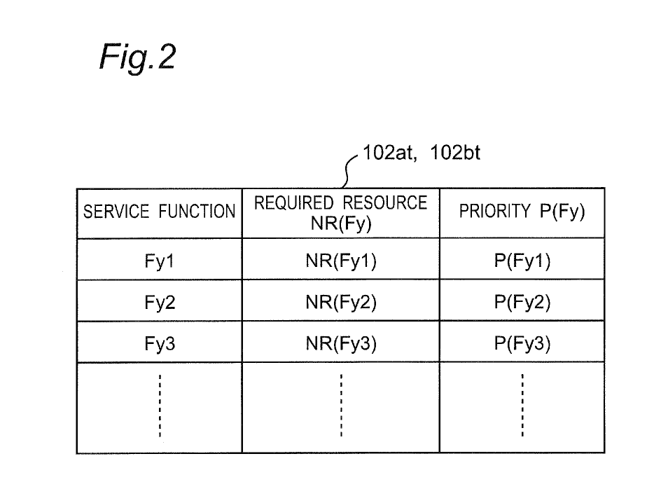

A plurality of service functions provided by the system exist separately in the servers 102a and 102b, and one or a plurality of M virtual servers 103a-1 to 103a-M and one or a plurality of N virtual servers 103b-1 to 103b-N operate to fulfill the service functions in the respective servers 102a and 102b. The virtual servers 103a-1 to 103a-M and 103b-1 to 103b-N are servers that operate virtually to perform communications with a client apparatus 101 by using a virtual IP address set for each service function in the servers 102a and 102b. The virtual servers 103a-1 to 103a-M and 103b-1 to 103b-N are managed by a method as described later by using the service function management tables 102 at and 102bt of FIG. 2 so that one service function is operated only in one server 102a or 102b.

Each client apparatus 101 communicates with a virtual server (one of 103a-1 to 103a-M and 103b-1 to 103b-N) having a virtual IP address allocated for each service function. In this case, by using the virtual IP address, the client apparatus 101 can operate without considering which of the servers 102a and 102b the virtual server corresponding to each service function is operating in. That is, even if the server 102a or 102b in which the virtual server is actually operating is changed, switchover of the virtual server can be not considered since each client apparatus 101 communicates with the other party's virtual server by using the virtual IP address.

The servers 102a and 102b transmit keep alive messages 104a and 104b for vital surveillance by using a multicast IP. For example, the server 102a judges that the server 102b is normally operating when receiving the keep alive message 104b of the other server 102b. Moreover, the keep alive messages 104a and 104b are transmitted periodically at definite periodic intervals. For example, when reception from the other server 102b cannot be achieved after a lapse of a definite period, it is determined that the server 102b has failed in an abnormal state. By thus making a judgment by transceiving the keep alive messages 104a and 104b by the server 102a, the state of the server 102b can be judged.

In this case, the server IDs of the servers 102a and 102b are defined as Sx (x=a, b), and the service function IDs are defined as Fyi (i=1, 2, . . . ) (generically referred to as a service function Fy). The resource of the server ID(Sx) is expressed as R(Sx) since the servers 102a and 102b have respective varied resources, and the required resource is defined as NR(Fyi) (i=1, 2, . . . ) (generically referred to as a required resource NR(Fy)) since each service function ID(Fyi) has a varied server resource amount used for each service function. Moreover, the priority of each service function ID(Fyi), which is also varied every service function, is therefore defined as P(Fyi) (i=1, 2, . . . ) (generically referred to as a priority P(Fy)).

FIG. 2 is a tabulation showing service function management tables 102 at and 102bt stored in the storage apparatuses of the servers 102a and 102b, respectively, of the load distribution server system of FIG. 1. As apparent from FIG. 2, the required resource NR(Fyi) and the priority P(Fyi) are preparatorily set for respective service functions Fyi (i=1, 2, . . . ) by the administrator. The priority P(Fyi) is set as 10, 9, . . . , 1, for example, in the order of higher priorities. For example, when the number and the resource amounts of the servers are changed or the operating service functions are increased or decreased in number, the changes can be reflected by setting the same changes.

With the above definitions, the remaining resource RR(Sx) of the server ID(Sx) is expressed by the following equation:

$$RR ( Sx ) = R ( Sx ) - {\sum }_{i} NR ( Fyi ) . \qquad ( 1 )$$

where Fyi denotes a service function ID operating with the server ID(Sx).

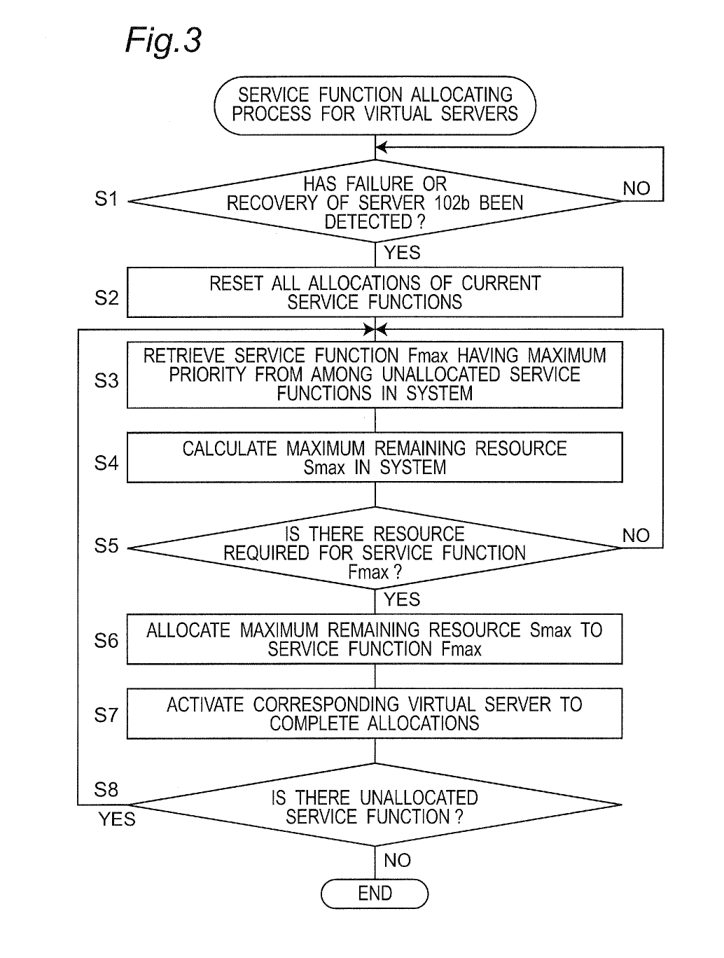

FIG. 3 is a flow chart showing a service function allocating process for virtual servers executed by the server 102a of the load distribution server system of the first preferred embodiment of the present invention. The servers 102a and 102b perform control of allocating each service function Fyi to the servers 102a and 102b by executing the service function allocating process of FIG. 2. The allocated service function Fyi is operated by activating the virtual servers 103a-1 to 103a-M and 103b-1 to 103b-N, and a service corresponding to the service function Fyi is provided for the client apparatus 101.

FIG. 3 shows a case where the processes in step S2 and the subsequent steps are executed when the server 102b detects a failure or recovery (S1). When the server 102a cannot receive the aforementioned keep alive message 104b in a definite interval and determines that the server 102b has failed or recovered (YES in S1), the server 102a totally resets allocation of the current service functions (S2), and thereafter, starts a recalculating process of the allocation of the virtual server.

First of all, a service function ID(Fmax) of the maximum priority P(Fyi) in the function ID(Fyi) scheduled to operate in the whole system is retrieved (S3). For example, assuming that the service functions scheduled to operate in the whole system are two service functions owned by the virtual servers 103a and 103b, when the virtual server 103b has a higher priority than the virtual server 103a, the virtual server 103b is required to preferentially operate. Next, Smax that is the maximum remaining resource RR(Sx) in the servers operable in the system is calculated (S4). In this case, the server resource R(Sx) of the server ID(Sx) of the server 102b becomes zero due to the failure of the server 102b, and therefore, the server 102a is consistently selected in the configuration of the two servers 102a and 102b. That is, a relation of server 102a=server ID(Smax) holds. In a configuration of three or more servers, the server having the maximum remaining resource amount is selected from among the operable servers.

Regarding the retrieved service function ID(Fmax) and server ID(Smax), the server ID(Smax) judges whether the service function ID(Fmax) has a required resource (S5). If there is a sufficient required resource (YES in S5), the service function ID(Fmax) is assigned to operate as the server ID(Smax) (S6). At this time, when the server ID(Smax) is the self-server ID, which is set to the server 102a, a virtual IP address corresponding to the service function ID(Fmax) is made effective to operate a virtual server 103b-n corresponding to the service function ID(Fmax) for update into an allocation completion state (S7). When there is an insufficient required resource (No in S5), the program flow returns to step S3, and processing from step S3 is repeated except for the retrieved service function.

If allocations of all the service function IDs are completed (No in S8), the service function allocating process is ended. If allocations of all the service functions are not completed (YES in S8), the processing from step S3 is repetitively executed again. That is, since the allocation of the virtual server 103a is not yet completed, the processing is repetitively executed. In order to operate a service function ID(Smax) of a higher priority, it is possible to search another operable server by the repetitive processing. If there is such a server, optimal relocation of the service functions can be achieved by performing reboot.

By the above allocation control, distributed allocation can be executed in a state in which the required resource of each service function ID(Fyi) is operable within the server resource R(Sx) owned by each server ID(Sx) according to the priority of the service functions.

Next, in a case where the server 102b that has been failed is recovered and transmission of the keep alive message 104b is restarted, the server 102a receives the keep alive message 104b and judges that the server 102b has been recovered, and sets the resource amount R(Sx) of the server ID(Sx) back to the initial setting value from zero to execute again the service function allocating process of FIG. 3. Moreover, the recovered server 102b executes allocation likewise as an initialization process. As a result, the service function is allocated to the recovered server 102b, and then a load distribution can be achieved. Moreover, by adding the server resource, it is possible to recover the low-priority service functions of the server 102a that has been stopped.

### Second Preferred Embodiment

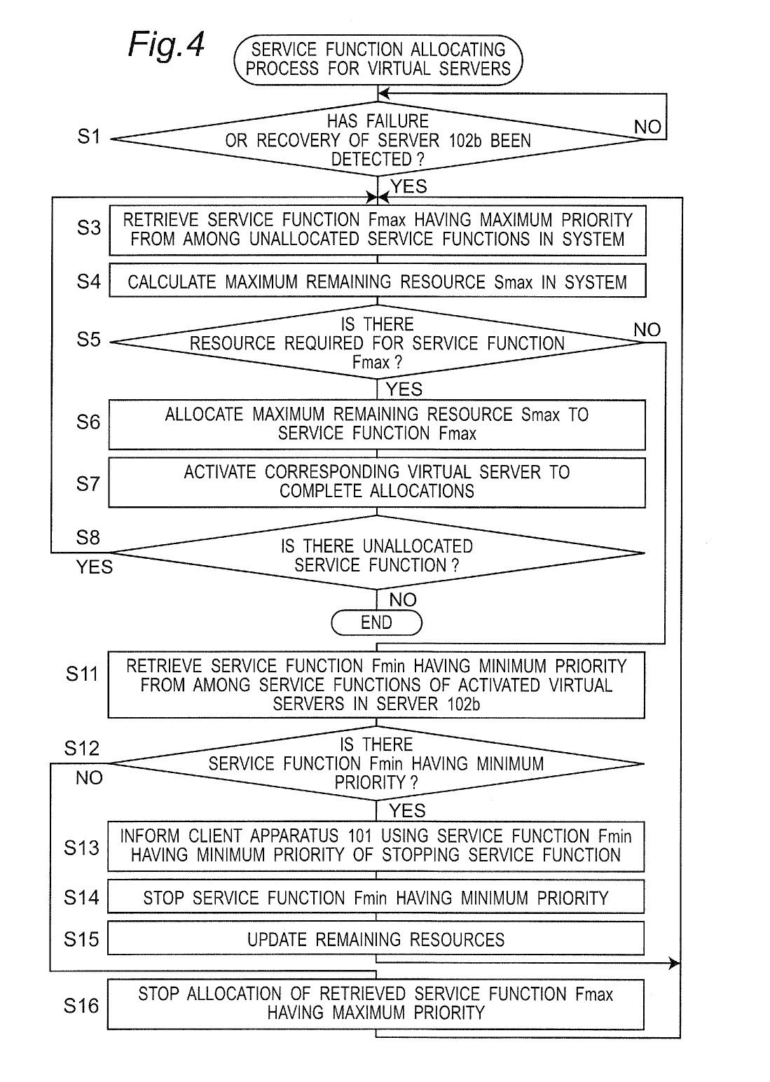

FIG. 4 is a flow chart showing a service function allocating process for virtual servers executed by the server 102a of a load distribution server system according to a second preferred embodiment of the present invention. The load distribution server system of the second preferred embodiment of the present invention has a configuration similar to that of FIG. 1, and the servers 102a and 102b have service function management tables 102 at and 102bt similar to those of FIG. 2. The present system is characterized in that the service function allocating process of FIG. 3 is replaced by the service function allocating process of FIG. 4. In comparison with the service function allocating process of FIG. 3, the service function allocating process of the second preferred embodiment is characterized in that:

(1) the process in step S2 is eliminated; and

(2) execution of “processes, when a service function Fmin having the minimum priority is retrieved and existing, for stopping the service function Fmin and so on in steps S11 to S16 when the answer is NO in step S5.

The processes in step S1 to step S8 of FIG. 4 are similar to those of FIG. 3 except for not executing the process in step S2. When the server resource amount of the server 102a is insufficient for a service function Fmax in step S5 (No in S5), a low-priority service function ID (Fmin) is retrieved (S11), and it is judged whether there is the required resource of the service function ID (Fmax) together with the remaining resource RR(Sx) (S12). In a case where the resource is insufficient, when there is a low-priority service function (YES in S12), the client apparatus 101 that is using the service function Fmin of the minimum priority is informed of stopping the service function Fmin (S13), and the service function Fmin of the minimum priority is stopped (S14). By stopping the function, the remaining resources are updated to increase the remaining resource amount of the server (S15), and it is judged again whether there is the required resource of the service function (S3).

When allocation has failed even if all the low-priority service functions are stopped (No in S12), the allocation of the retrieved service function Fmax having the maximum priority is stopped, and an allocation completion state is established (S16). In this case, when the virtual server 103a judges that there is a required resource, and the replacement of the service function is possible, the low-priority service function of the server 102a is stopped according to the priority of the service functions, and replaced by a high-priority service function of the server 102b, so that the server 102a can continue processing.

By the above allocation control, distributed allocation can be executed in a state in which the required resource of each function ID-Fx is operable within the server resource R(Sx) owned by each server ID(Sx) according to the priority of the service functions.

Next, when the server 102b that has failed is recovered and the transmission of the keep alive message 104b is restarted, the server 102a receives the keep alive message 104b and judges that the server 102b has recovered, and the resource amount R(Sx) of the server ID(Sx) is set back to the initial setting value from zero to execute again the service function allocating process of FIG. 4. Moreover, the recovered server 102b executes allocation likewise as an initialization process. As a result, the service function is allocated to the recovered server 102b, achieving load distribution. Moreover, by adding the server resource, it is possible to recover the low-priority service functions of the server 102a that has been stopped.

### Modified Preferred Embodiment

Although the case where there are two servers has been described above in the present preferred embodiment of the present invention, the present invention is not limited to this. When there are more number of servers, the service function of the server 102b replaced by the server 102a can be shared by a plurality of servers. As described above, by replacing the high-priority function of the failed server among the plurality of servers with the own low-priority function of another server, the processing of the high-priority function can be continued without degrading the performance.

The above load distribution server system can also be provided for not only the airplane service system but also other server systems like a train service system, a bus service system, and a broadcasting system.

### INDUSTRIAL APPLICABILITY

The load distribution server system of the present invention is able to improve the effective use of the server resources and the system reliability by allowing the servers to be distributed and redundant concerning the service functions according to the priority, and useful as mobile object service systems of aircrafts, trains and the like to provide television broadcasting and announcement services for individual passengers.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A load distribution server system for providing a plurality of services on demand from a client apparatus, to which a plurality of servers are connected via a network for the client apparatus,
wherein the plurality of servers operate as virtual servers for the client apparatus,
wherein the plurality of servers take charge of the plurality of services to share respective service functions and mutually transceive keep alive messages, and
wherein, when the keep alive message of at least one server is not received or when reception of the keep alive message is restarted in at least one server, the service function of the server of which the keep alive message is not received is allocated to at least one other server on the basis of a predetermined priority of the service function, and a virtual server corresponding to the allocated service function is activated to provide the service of the service function.

2. The load distribution server system as claimed in claim 1,
wherein, when the keep alive message of at least one server not received or when reception of the keep alive message is restarted in at least one server, at least one other server retrieves a service function having a maximum priority among the service functions that have not been allocated in the load distribution server system, and in a case where there is a resource required for the service function, the retrieved service function is allocated to the resource, and a virtual server corresponding to the allocated service function is activated to provide the service of the service function.

3. The load distribution server system as claimed in claim 1,
wherein, when the keep alive message of at least one server is not received or when reception of the keep alive message is restarted in at least one server, at least one other server retrieves a service function having a maximum priority among the service functions that have not been allocated in the load distribution server system, and in a case where there is a service function having a minimum priority when there is no resource required for the service function, the service function is stopped and the remaining resources are updated, and thereafter, the service function having the maximum priority is retrieved from among the service functions that have not been allocated in the load distribution server system.

4. The load distribution server system as claimed in claim 3,
wherein, when the keep alive message of at least one server is not received or when reception of the keep alive message is restarted in at least one server, at least one other server retrieves the service function having the maximum priority from among the service functions that have not been allocated in the load distribution server system, and in a case where there is no service function having the minimum priority when there is no resource required for the service function, allocation of the service function having the maximum priority is stopped.

5. The load distribution server system as claimed in claim 1,
wherein the load distribution server system is a service system provided in an aircraft.

6. The load distribution server system as claimed in claim 2,
wherein the load distribution server system is a service system provided in an aircraft.

7. The load distribution server system as claimed in claim 3,
wherein the load distribution server system is a service system provided in an aircraft.

8. The load distribution server system as claimed in claim 4,
wherein the load distribution server system is a service system provided in an aircraft.
